(19) United States
(12) Patent Application Publication
(10) Pub. No.: US 2004/0267724 A1
(43) Pub. Date: Dec. 30, 2004

(54) Apparatus, system and method of calling a reader's attention to a section of a document

(75) Inventor: Richard Dale Hoffman, Austin, TX (US)

Correspondence Address: Mr. Volel Emile, P.O. Box 202170, Austin, TX, 78720-2170, US

(73) Assignee: International Business Machines Corporation, Armonk, NY

(21) Appl. No.: 10/610,786

(22) Filed: Jun. 30, 2003

(51) Int. Cl. G06F 7/00

(52) U.S. Cl. 707/3

(57) ABSTRACT

An apparatus, system and method of calling a reader's attention to a section of a document are provided. The document is requested using a uniform resource locator (URL) that includes a search term. Upon receiving the document, it is determined whether there is an anchor in the Web page by the search term. If not, the document is parsed for the search term and displayed at a location that coincides with the location of the search term in the document. In another embodiment, before the document is provided to the requester, the document is parsed for the search term if there is not an anchor by the search term. When the search term is found, it is converted to a named anchor by insertion of anchor tags around the search term. After the tags are inserted, the document is passed to the requester.

### BACKGROUND OF THE INVENTION

1. Technical Field:

The present invention is directed to a communications network. More specifically, the present invention is directed to an apparatus, system and method of calling a reader's attention to a section of a document without using a named anchor.

2. Description of Related Art:

Markup languages (e.g., Extensible Markup Language (XML), Hyper Text Markup Language (HTML), Standard Generalized Markup Language (SGML) etc.) support links to documents as well as to graphics, audio and video files. Links are references to documents from within other documents. When activated via a mouse, keyboard input, voice commands, etc., links allow users to jump from one document to another.

To create links inside a document, anchors are used. Anchors enable document creators to specify where users are to go next when reading a document. Generally, an anchor is a URL (Uniform Resource Locator) which ties a region of a document (e.g., a button, an image or some text) to another document. In conjunction with or in lieu of using anchors, named anchors may be used. Named anchors allow a user to jump directly into a specific section of a document. Named anchors are often used in FAQ (Frequently Asked Questions) HTML files where each question is linked to an answer. In addition, named anchors are used in Tables of Contents of Web documents where each item in the Tables is linked to a related section or chapter in the documents.

Because named anchors allow users to jump to specific sections of documents, they are often used to focus attention to particular sections of documents instead of vaguely describing the sections deserving the attention. For example, when a user desires that the attention of a reader be focused on a particular section of a document, the user may transmit the link or URL (including the named anchor) of the document to the reader. When the reader activates the link, the document will be displayed at that section.

Clearly, the document must have been created with a named anchor relating to the section in question. Otherwise, the user may have to provide the location of the section in the document. It is important to distinguish here between the author of the document, who controls its contents and the placement of named anchors therein, and an ordinary user, who may not alter the document in any way. Thus, unless an author of a document had happened to create a named anchor at a point convenient to a user, the user may have to fully describe the section in question. Obviously, identifying a section or a passage in a long document through its description may at times be difficult.

Thus, a need exists for an apparatus, system and method of calling a reader's attention to a section of a document that does not have an associated named anchor and without describing the location of the section.

### SUMMARY OF THE INVENTION

The present invention provides an apparatus, system and method of calling a reader's attention to a particular section of a document. A user who wishes to call a reader's attention to a section of a document, may add a search term to a Uniform Resource Locator (URL) and pass the URL to the reader (the URL being the address of the document). When the reader accesses the document using the URL, the following procedure occurs. First, it is determined whether there is an anchor in the document having a name that is identical to the search term. If not, the document is parsed for the search term in the URL. The document will then be displayed where the search term is found.

In another embodiment, the document is accessed before it is provided to a requester to determine whether there is an anchor by a name that is identical to the search term, the search term being part of the URL of the document. If there is not, the document will be parsed for the search term. When the search term is found, it is converted to a named anchor by insertion of anchor tags around the search term. After the tags are inserted, the document is passed to the requester.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 depicts representative HTML tags used to link text to a page on a Web site.

FIG. 5 depicts a named anchor.

FIG. 6 is a link to a named anchor within a document containing the named anchor.

FIG. 7 is a link to a named anchor within a document that is different from the one containing the named anchor.

FIG. 8 depicts attributes that may be used in conjunction with the present invention.

FIG. 9 depicts an example of a link in accordance with the present invention.

FIG. 10 is flow diagram of a process that a browser may use to implement the present invention.

FIG. 11 illustrates a flow diagram of a process that a server may use to implement the invention.

### DETAILED DESCRIPTION OF THE PREFERRED EMBODIMENT

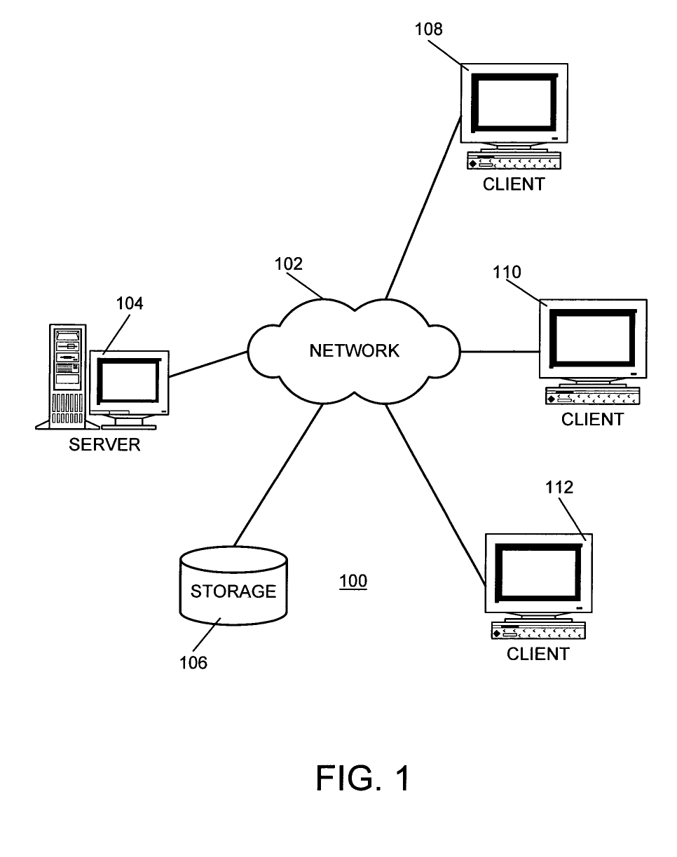

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN) . FIG. 1 is intended as an example, and not as an architectural limitation for the present invention.

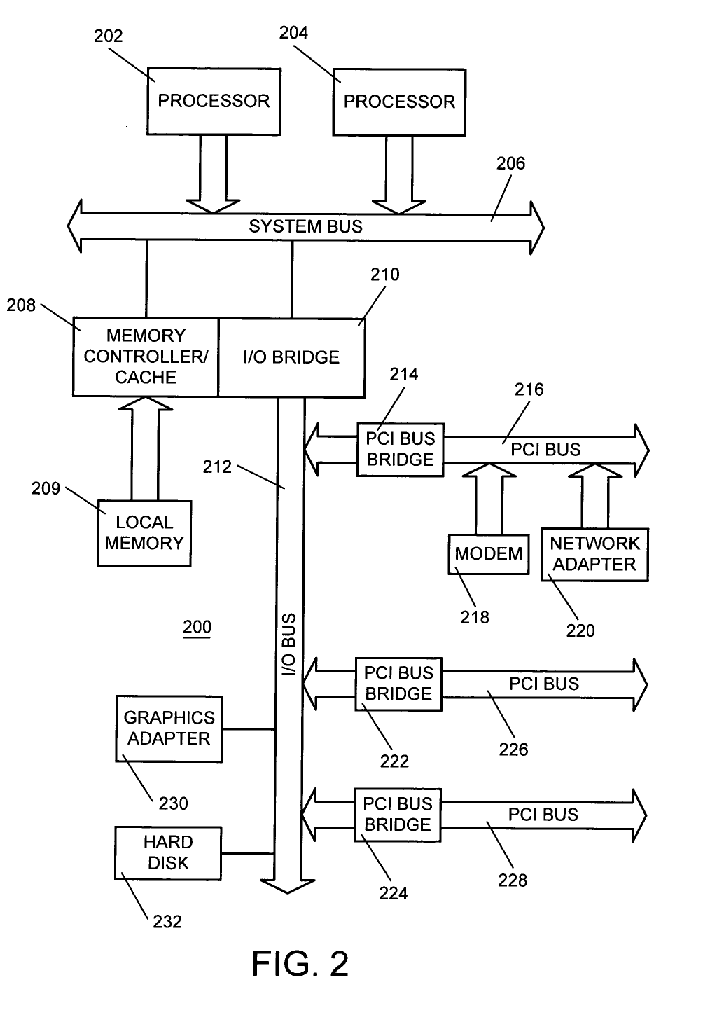

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, New York, running the Advanced Interactive Executive (AIX) operating system or LINUX operating system.

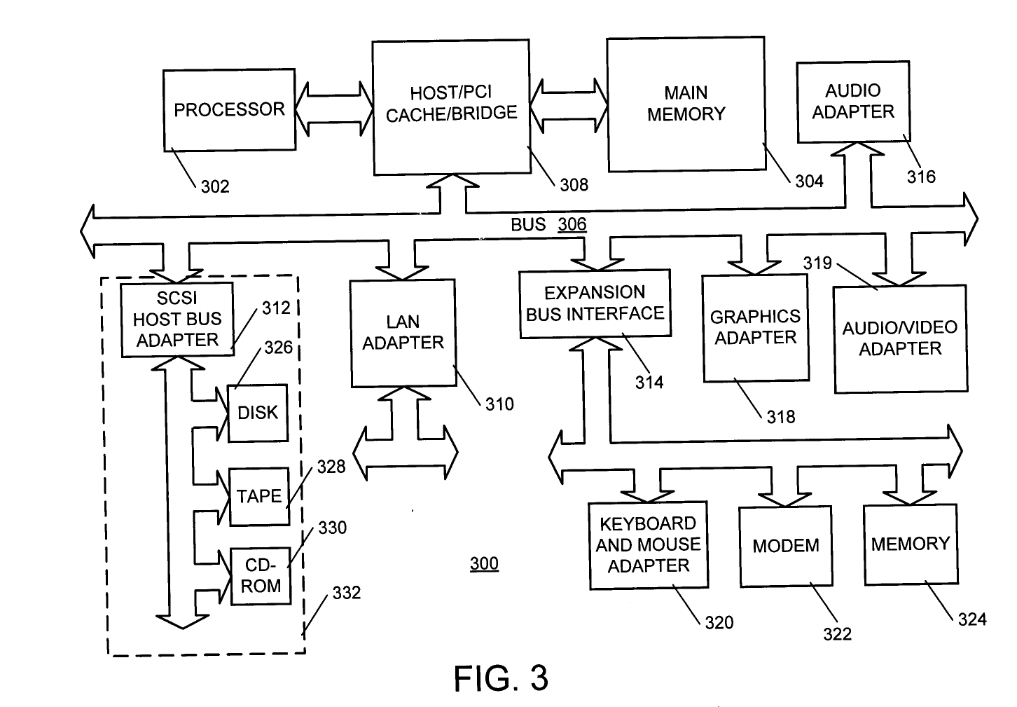

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides an apparatus, system and method of calling a reader's attention to a section of a document without the use of named anchors. The invention may be local to client systems 108, 110 and 112 of FIG. 1 or to the server 104 or to both the server 104 and clients 108, 110 and 112. Further, the present invention may reside on any data storage medium (i.e., floppy disk, compact disk, hard disk, ROM, RAM, etc.) used by a computer system.

The invention will be described using the client-server model of FIG. 1 as well as using HTML. Server, in the context of the invention, is any computer system that is passing a requested document to a requester. Thus, the invention will work equally as well in a peer-to-peer environment (i.e., between any two of client systems 108, 110 and 112). Indeed, the invention will work on a single computer system (i.e., where a document being requested resides on the computer system that is requesting the document). Further, HTML is used to facilitate the understanding of the invention. However, the invention is not thus restricted; any markup language can be used and is within the scope and spirit of the invention. Consequently, the use of the client-server model and of HTML in the description of the invention is for illustrative purposes only.

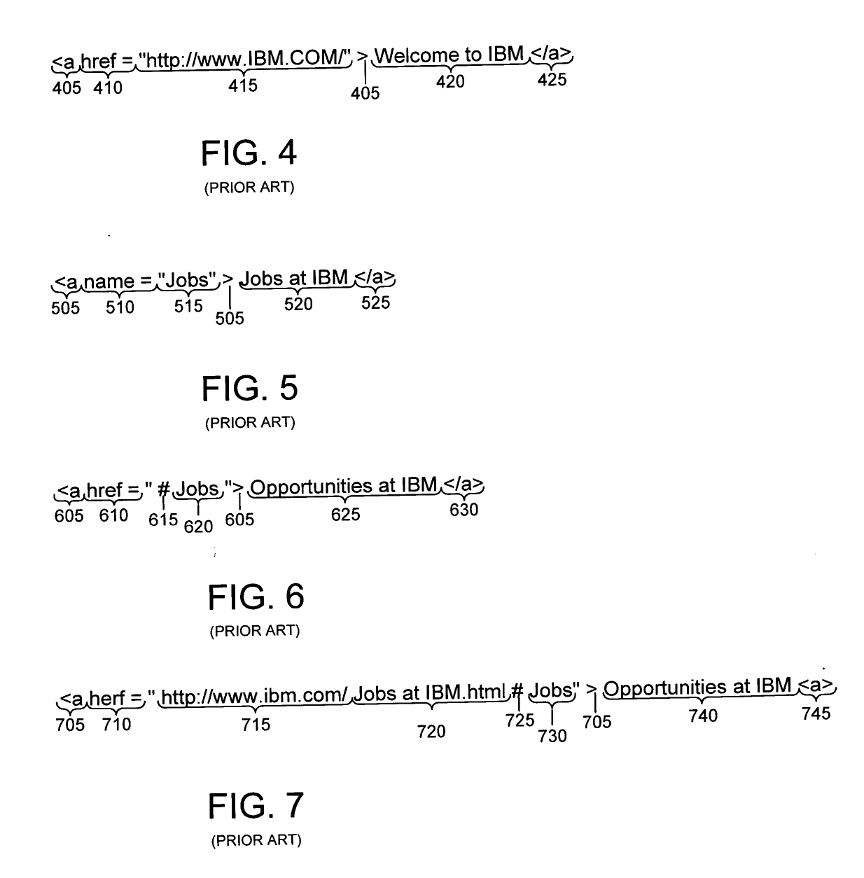

As is well known in the field, to link to a file on a Web server, HTML tags are used. FIG. 4 depicts representative HTML tags that are used to link text to a page on a Web site. In this figure, there is an open anchor tag <a> 405 and a close anchor tag </a> 425. A hypertext reference (href 410) and a Web address (http://www.ibm.com 415). The hypertext reference, href 410, and the Web address, http://www.ibm.com 415, are entered within the open anchor tag 405. The figure also contains a block of text (i.e., Welcome to IBM 420). The block of text is between the beginning and ending anchor tags 405 and 425.

In this example, the block of text, Welcome to IBM 420, is linked to the Web address http://www.ibm.com 415. The block of text 420 is what is displayed (generally in a highlighted fashion) in a browser when the HTML file containing FIG. 4 is accessed. The block of text may be activated via a mouse, keyboard input, voice commands, etc. When activated, the WWW.IBM.COM Web site will be accessed.

As mentioned earlier, to link to a specific section of a document, an anchor name has to be defined inside the document and at that section. FIG. 5 depicts a named anchor. As before, an open anchor tag (<a> 505) and close anchor tag (</a> 525) are used. The anchor is named using a NAME attribute (name 510) that is set to a name (Jobs 515). The NAME attribute and the name are inserted within the open anchor tag <a> 505. The first line of the section in the document (i.e., Jobs at IBM 520) is entered between the open anchor tag <a> 505 and the close anchor tag </a> 525.

Next, a link to the named anchor “Jobs” has to be created. If the link is within the same document as the named anchor, the HTML code shown in FIG. 6 is used at a location in the HTML file where the link is to be displayed. If the link is in a different document than the document containing the named anchor, the HTML code in FIG. 7 is used.

In FIG. 6, an open anchor tag <a>605 and a close anchor tag </a> 630 are used. A hypertext reference (href 610), a pound sign (#) 615 and the name of the anchor (i.e., Jobs 620) are inserted into the open anchor tag <a> 605. Since the hypertext reference href 610 is not set to a Web address, the browser displaying the document will look inside the loaded document for the named anchor. Incidentally, the pound sign, # 615, announces the name of the anchor, Jobs 620. The block of text (i.e., Opportunities at IBM 625) is what is displayed in a highlighted fashion in the browser when the HTML file containing FIG. 6 is accessed. When the block of text 625 is activated, the document will be automatically scrolled to the section in the document where the text “Jobs at IBM” (see FIG. 5) is located.

In FIG. 7, just as in FIG. 6, an open anchor tag <a> 705 and a close anchor tag </a> 745 are used. A hypertext reference (href 710) sets to a Web address (http://www.ibm.com/ 715) is used. Further, the name of the HTML file that contains the named anchor (i.e., jobsatIBM.html 720) is also provided. Pound sign (#) 725 is placed in front of the anchor name, Jobs 730. The href 710, web address 715, HTML file name 720 pound sign # 725 and the anchor name 730 are all inserted inside the open anchor tag <a> 705. The block of text (i.e., Opportunities at IBM 740) will be displayed in a highlighted fashion in the browser when the HTML file containing FIG. 7 is accessed.

If the block of text (i.e., Opportunities at IBM 740) is activated, the browser will go to the IBM Web site (http://www.ibm.com/ 715) load the file JobsatIBM.html 720. After loading the file, the browser, using the name of the anchor (i.e., Jobs 730), will display the document (represented by the file) at the Jobs at IBM 520 section (see FIG. 5). Likewise, if a user directly accesses the document JobsatIBM.html using the address http://www.ibm.com/JobsatIBM.html#Jobs, the browser will display the document at the Jobs at IBM 520 section. Consequently, if a user wants to focus a recipient's attention to the Job section on the IBM Website, the user may pass the address http://www.ibm.com/JobsatIBM.html#Jobs to the recipient. When the recipient accesses the IBM Web site using that address, the Job Section will be displayed. Thus, named anchors may be a rather good tool for focusing a user's attention to a particular section of a Web document.

As mentioned above, however, if the document (i.e., JobsatIBM.html) was created without the named anchor Jobs 515 (see FIG. 5), when the recipient accesses the IBM Website using the address http://www.ibm.com/JobsatIBM.html#Jobs, the document would be displayed at its beginning rather than at the Job Section. The present invention allows for a user, as opposed to a document author or creator, to determine what section of a document will be displayed when the document is accessed. To continue with the example above, if the user wants to focus a reader's attention specifically to UNIX programming jobs at IBM and if the user is aware that the term “UNIX PROGRAMMERS NEEDED” is used in the section where the programming jobs are listed, the user may add UNIX_PROGRAMMERS_NEEDED to the URL of the document (i.e., http://www.ibm.com/JobsatIBM.html). The addition will be used as a search term by the present invention. Note that the search term is added to the URL using the named anchor syntax. In any event, after adding the search term to the URL of the document, the URL will be as follows: http://www.ibm.com/JobsatIBM.html#UNIX_PROGRAMMERS_NEEDED. This URL may then be passed to a recipient/reader via e-mail for example.

When the reader accesses the document using that address, the browser will first parse the JobsatIBM.html file for an anchor by the name of UNIX_PROGRAMMERS_NEEDED. If the anchor is not found, then the browser will search the file for the term UNIX PROGRAMMERS NEEDED. The browser will then display the document at the section that contains the search term. In searching for the term, the underscores are disregarded.

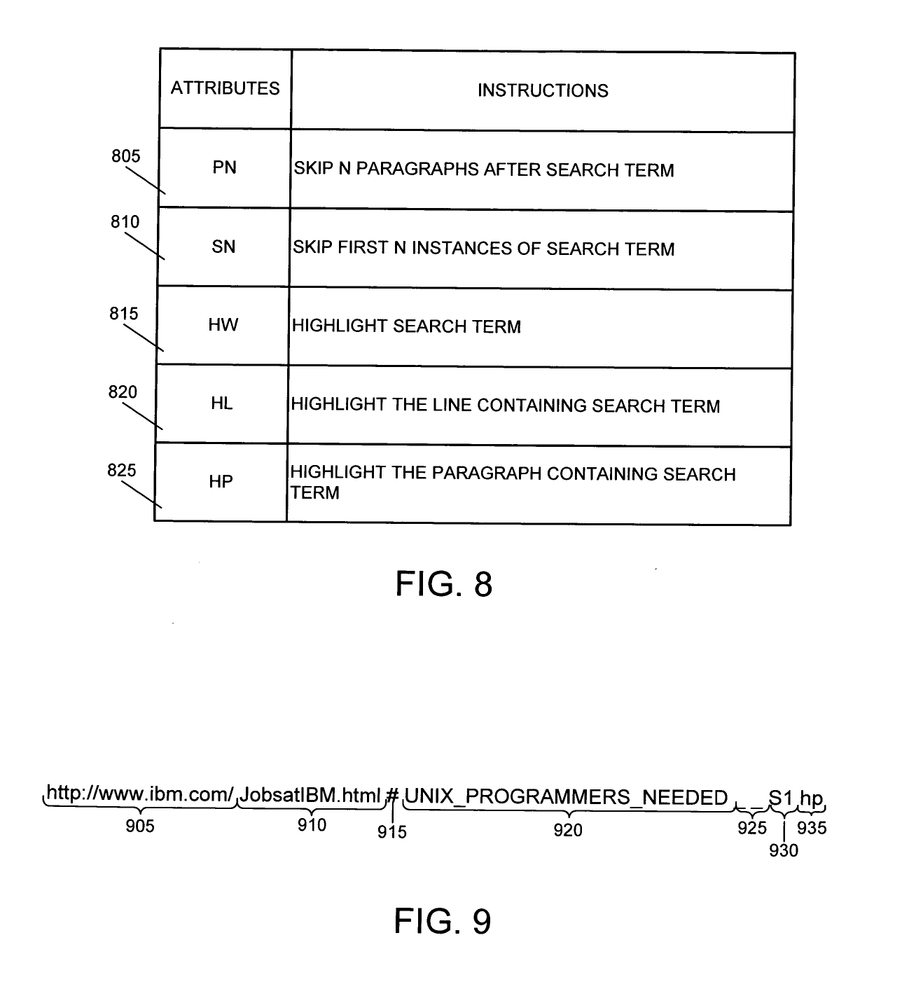

To further provide instructions to the browser, a plurality of attributes may be used in conjunction with the search term. FIG. 8 depicts the attributes. Note that the list in FIG. 8 is used for illustrative purposes only and thus the items listed therein are not all inclusive.

The attributes in FIG. 8 include pn 805, sn 810, hw 815, hl 820 and hp 825, where n in pn and sn is an integer. When attribute pn 805 is used, the browser will skip n paragraphs after locating the search term and display the document at paragraph n+1. When attribute sn 810 is used, the browser will skip the first n instances of the search term and will display the document at the (n+1)^{th} instance of the search term. Attribute hw 815 instructs the browser to highlight the search term. Attribute hi 820 instructs the browser to highlight the line containing the search term while attribute hp 825 instructs the browser to highlight the paragraph in which the search term is located.

As an example, to locate the second paragraph containing the term UNIX PROGRAMMERS NEEDED and to highlight that paragraph, the user may pass the link depicted in FIG. 9 to a recipient/reader. The link includes a Website address (http://www.ibm.com/ 905), a document (JobsatIBM.html 910), a pound sign (# 915), a search term (UNIX_PROGRAMMERS_NEEDED 920), two underscores (__ 925), a first attribute (s1 930) and a second attribute (hp 935).

The Website address 905 and the name of the document 910 constitute the network address of the document. The pound sign (# 915) instructs the browser to look for an anchor with a name that coincides with the name that follows the pound sign. In accordance with the invention, however, if there is no such named anchor in the document, the name following the pound sign will be taken as a search term. Hence, the browser will search for that term in the document.

The two underscores (i.e., __ 925) notify the browser that there is at least one attribute with the search term. In this case, there are two attributes, attribute s1 930 and hp 935. Attribute s1 930 instructs the browser to skip the first instance of the search term in the document. Thus, the browser will display the document at the second instance of the term. Attribute hp 935 instructs the browser to highlight the paragraph that contains the search term. Consequently, the paragraph which constitutes the point at which the browser displays the document will be highlighted.

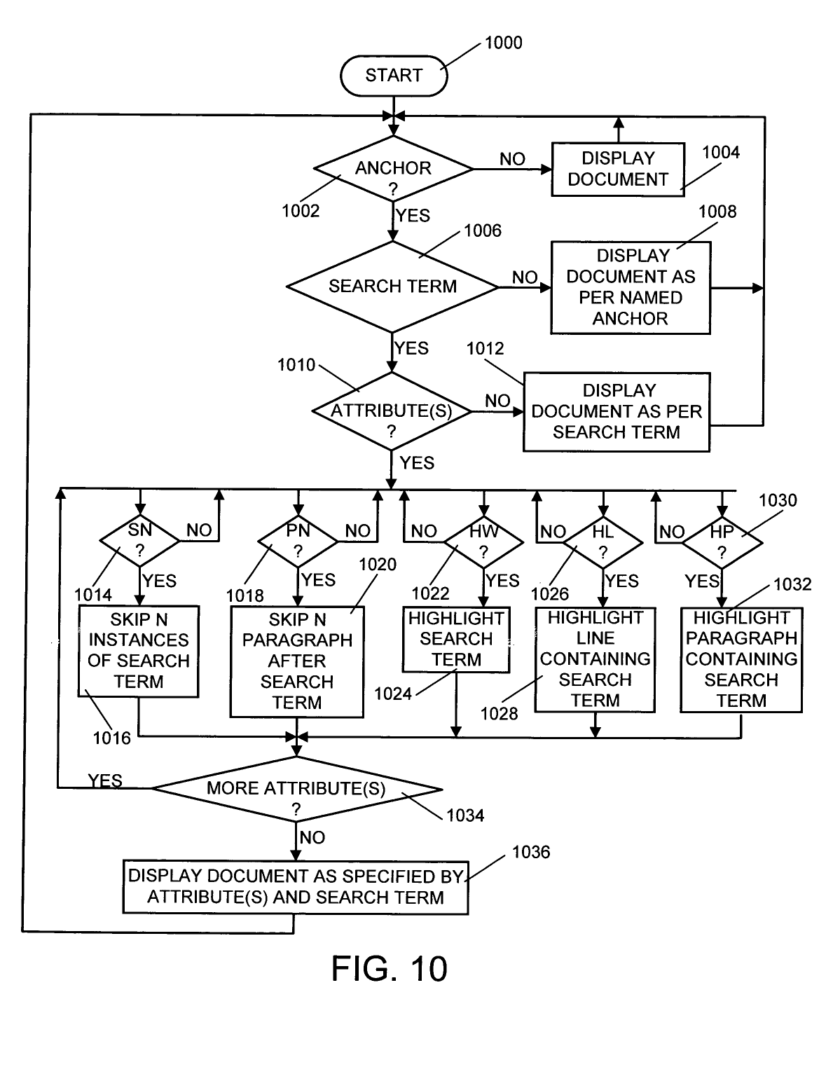

FIG. 10 is a flow diagram of a process that may be used to implement the present invention. The process starts when a browser is instantiated (step 1000). Then, each time a link is used to access a document, a check is made to determine whether there is a search term in the link (step 1002). As mentioned earlier, the presence of a pound sign (#) indicates that a search term is provided. If not, the document will be displayed as customary (step 1004.

If there is a search term provided, then it will be determined whether the search term is the name of an anchor in the document. Named anchors are usually clearly defined in documents. Hence, if the search term coincides with a named anchor, then the document will be displayed as per the rules regarding named anchors (steps 1006 and 1008). But, if there is not an anchor by the search term, then the document will be parsed for the search term. Thus, the browser will search the document for instances of the search term. Before displaying the document, however, the browser will check to see whether there are any attributes. As mentioned before, the presence of a double underscore indicates that there is at least one attribute present. If there is not any attribute, the browser will display the document at the paragraph having the first instance of the search term (steps 1010 and 1012).

If there is at least one attribute present, the browser will take the attribute in consideration before displaying the document. For example, if the attribute is sn 810, the document will be displayed at the (n+1)^{th} instance of the search term. If the attribute is pn 805, the document will be displayed at (n+1)^{th} paragraph following the paragraph in which the search term is found. If the attribute is hw 815 then the search term will be highlighted in the document. Further, if the attribute is hl 820, the line containing the search term will be highlighted where if the attribute is hp 825, the paragraph containing the search term will be highlighted. As shown by the example above, more than one attribute may be present at any one time. After displaying the document, the process will return to step 10002 (steps 1014, 1016, 1018, 1020, 1022, 1024, 1026, 1028, 1030, 1032, 1034 and 1036).

The invention may be used as a plug-in to retrofit browsers that are presently in use. Specifically, the first time a browser does not encounter an anchor that has a name that coincides with a search term, the browser may download and install the invention. Thereafter, the browser may proceed as outlined in FIG. 10.

Alternatively, the invention may be installed into servers. A server that incorporates the invention will perform all the steps outlined in FIG. 10. In addition, the server will dynamically insert appropriate tags into HTML files in order to implement the invention. For example, if a user uses the URL shown in FIG. 9 to access the JobsatIBM.html document, the server will load the document. Then, the server may check to see whether the search term is the name of an anchor in the document. If so, the server may pass the document to the client browser. If not, the server may parse the document for the provided search term being mindful of attributes. In the example above, the server may insert the search term as a named anchor at the second occurrence of the search term. In addition, the server may include instructions that will enable the browser to highlight the paragraph that contains the server-inserted named anchor (i.e., insert highlighting tags around the paragraph).

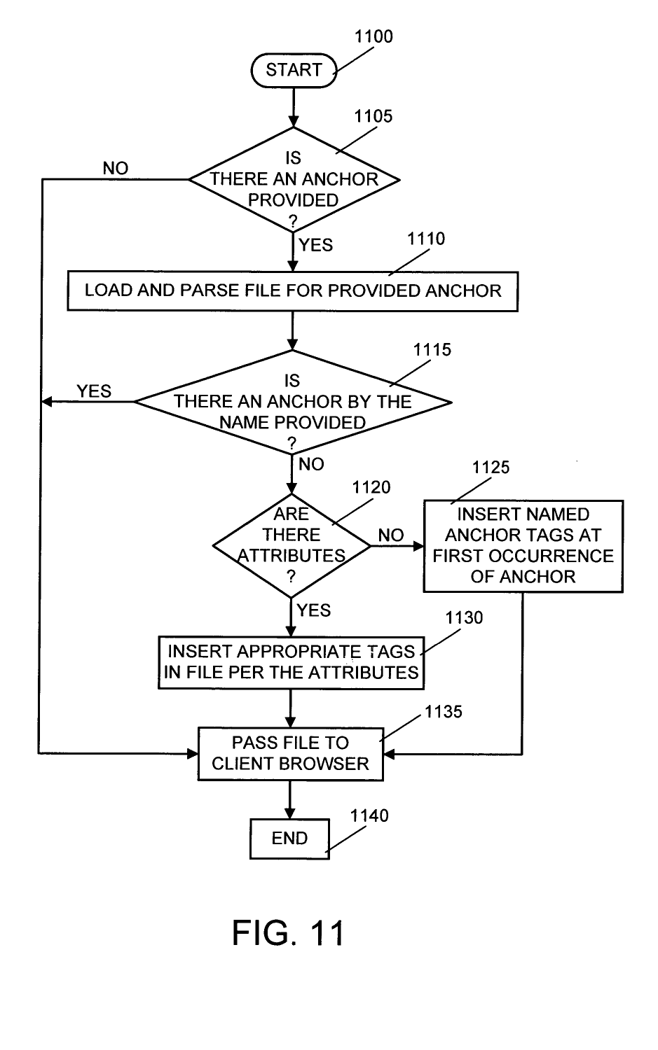

FIG. 11 illustrates a flow chart of a process that a server may use to implement the invention. The process starts each time the server receives a request for a file (step 1100). Then a check is made to determine whether there is a search term in the URL provided. If not, the server may pass the file to the client browser and the process ends (steps 1105, 1135 and 1140).

If there is a search term, the server may then load the document to determine whether the search term is a named anchor (steps 1105, 1100 and 1115). If it is a named anchor, the server may pass the document to the client browser and the process ends (steps 1115, 1135 and 1140).

If the search term is not a named anchor, the server may check to see whether there are any provided attributes. If not, the server may insert named anchor tags at the first occurrence of the search term in the document before passing the document to the client browser and the process ends (steps 1120, 1125, 1135 and 1140). If there are provided attributes, the server may insert appropriate tags (i.e., named anchor tags, highlighting tags etc.) as per the attributes. Then, the server may pass the document to the client browser and the process ends (steps 1120, 1130, 1135 and 1140).

Thus, the invention provides a means to specify, within the rules of existing HTML, a specific point of focus within a document and to highlight that point of focus. A browser that supports the invention will treat a named anchor reference in a URL as a search target if no such named anchor exists in the target document. The invention may also include instructions for highlighting certain section of the document. The advantages of this include: (1) being able to specify a URL that focuses directly on any portion of a document; (2) being able to highlight any portion of the document for accentuation; while accomplishing all this without additional HTML syntax.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of calling a reader's attention to a section of a document comprising the steps of:
adding a search term to a Uniform Resource Locator (URL), the URL being an address of the document, the search term being used to determine whether it is a match to a named anchor in the document and to display the document at the section in which the search term is located if it is not a match; and
passing the URL to the reader.

2. The method of claim 1 wherein the URL further includes at least one attribute, the attribute indicating at which instance of the search term to display the document.

3. The method of claim 1 wherein the URL further includes at least one attribute, the attribute providing instructions to highlight the search term.

4. The method of claim 1 wherein the URL further includes at least one attribute, the attribute providing instructions to highlight a line of text in which the search term is located.

5. The method of claim 1 wherein the URL further includes at least one attribute, the attribute providing instructions to highlight a paragraph in which the search term is located.

6. A method of displaying a document identified by a Uniform Resource Locator (URL) comprising the steps of:
accessing the document using the URL, the URL including a provided search term;
determining whether there is a named anchor in the document by the search term;
parsing the document, if there is not a named anchor in the document by the search term, for the search term; and
displaying the document at a location that coincides with the location of the search term in the document.

7. The method of claim 6 wherein the URL further includes at least one attribute, the attribute indicating at which instance of the search term to display the document.

8. The method of claim 7 wherein the URL further includes at least one attribute, the attribute providing instructions to highlight the search term.

9. The method of claim 7 wherein the URL further includes at least one attribute, the attribute providing instructions to highlight a line of text in which the search term is located.

10. The method of claim 7 wherein the URL further includes at least one attribute, the attribute providing instructions to highlight a paragraph in which the search term is located.

11. A method of displaying a Web page in a browser comprising the steps of:
requesting the Web page from a computer system using a uniform resource locator (URL), the URL including a search term;
receiving the Web page from the computer system;
determining whether there is a named anchor by the search term in the received Web page;
parsing the Web page for the search term if there is not a named anchor in the Web page by the search term; and
displaying the Web page at a location that coincides with the location of the search term in the Web page.

12. The method of claim 11 wherein the URL further includes a first attribute, the first attribute providing instructions to highlight the search term.

13. The method of claim 12 wherein the URL further includes a second attribute, the second attribute indicating which instance of the search term to highlight.

14. The method of claim 12 wherein the URL further includes a second attribute, the second attribute indicating a line of text in which the search term is located to highlight.

15. The method of claim 12 wherein the URL further includes a second attribute, the second attribute indicating a paragraph in which the search term is located to highlight.

16. A method of providing a Web page to a second computer system by a first computer system comprising the steps of:
receiving a request for the Web page from the second computer system, the request including a uniform resource locator (URL) with a search term;
accessing the Web page identified by the URL;
determining whether there is a named anchor in the Web page by the search term;
parsing the Web page, if there is not a named anchor in the Web page by the search term, for the search term;
inserting in the Web page anchor tags around the search term if a named anchor is not found; and
transferring the Web page to the second computer system.

17. The method of claim 16 wherein the URL further includes a first attribute, the first attribute instructing the server to insert tags in the Web page to highlight the search term.

18. The method of claim 17 wherein the URL further includes a second attribute, the second attribute indicating to the server around which instance of the search term anchor tags and highlighting tags are to be inserted.

19. The method of claim 17 wherein the URL further includes a second attribute, the second attribute instructing the server to insert highlighting tags around a line of text containing the search term.

20. The method of claim 17 wherein the URL further includes a second attribute, the second attribute instruction the server to insert highlighting tags around a paragraph containing the search term.

21. A computer program product on computer readable medium for displaying a document identified by a Uniform Resource Locator (URL) comprising:
code means for accessing the document using the URL, the URL including a provided search term;
code means for determining whether there is a named anchor in the document by the search term;
code means for parsing the document, if there is not a named anchor in the document by the search term, for the search term; and
code means for displaying the document at a location that coincides with the location of the search term in the document.

22. The computer program product of claim 21 wherein the URL further includes at least one attribute, the attribute indicating at which instance of the search term to display the document.

23. The computer program product of claim 21 wherein the URL further includes at least one attribute, the attribute providing instructions to highlight the search term.

24. The computer program product of claim 21 wherein the URL further includes at least one attribute, the attribute providing instructions to highlight a line of text in which the search term is located.

25. The computer program product of claim 21 wherein the URL further includes at least one attribute, the attribute providing instructions to highlight a paragraph in which the search term is located.

26. A computer program product on a computer readable medium for displaying a Web page in a browser comprising:
code means for requesting the Web page from a computer system using a uniform resource locator (URL), the URL including a search term;
code means for receiving the Web page from the computer system;
code means for determining whether there is a named anchor by the search term in the received Web page;
code means for parsing the Web page for the search term if there is not a named anchor in the Web page by the search term; and
code means for displaying the Web page at a location that coincides with the location of the search term in the Web page.

27. The computer program product of claim 26 wherein the URL further includes a first attribute, the first attribute providing instructions to highlight the search term.

28. The computer program product of claim 27 wherein the URL further includes a second attribute, the second attribute indicating which instance of the search term to highlight.

29. The computer program product of claim 27 wherein the URL further includes a second attribute, the second attribute indicating a line of text in which the search term is located to highlight.

30. The computer program product of claim 27 wherein the URL further includes a second attribute, the second attribute indicating a paragraph in which the search term is located to highlight.

31. A computer program product on a computer readable medium for providing a Web page to a second computer system, the Web page being stored on a first computer system, the computer program product comprising:
code means for receiving a request for the Web page from the second computer system, the request including a uniform resource locator (URL) with a search term;
code means for accessing the Web page identified by the URL;
code means for determining whether there is a named anchor in the Web page by the search term;
code means for parsing the Web page, if there is not a named anchor in the Web page by the search term, for the search term;
code means for inserting in the Web page anchor tags around the search term if a named anchor is not found; and
code means for transferring the Web page to the second computer system.

32. The computer program product of claim 31 wherein the URL further includes a first attribute, the first attribute instructing the server to insert tags in the Web page to highlight the search term.

33. The computer program product of claim 21 wherein the URL further includes a second attribute, the second attribute indicating to the server around which instance of the search term anchor tags and highlighting tags are to be inserted.

34. The computer program product of claim 32 wherein the URL further includes a second attribute, the second attribute instructing the server to insert highlighting tags around a line of text containing the search term.

35. The computer program product of claim 32 wherein the URL further includes a, second attribute, the second attribute instruction the server to insert highlighting tags around a paragraph containing the search term.

36. An apparatus for displaying a document identified by a Uniform Resource Locator (URL) comprising:
means for accessing the document using the URL, the URL including a provided search term;
means for determining whether there is a named anchor in the document by the search term;
means for parsing the document, if there is not a named anchor in the document by the search term, for the search term; and
means for displaying the document at a location that coincides with the location of the search term in the document.

37. The apparatus of claim 36 wherein the URL further includes at least one attribute, the attribute indicating at which instance of the search term to display the document.

38. The apparatus of claim 36 wherein the URL further includes at least one attribute, the attribute providing instructions to highlight the search term.

39. The apparatus of claim .36 wherein the URL further includes at least one attribute, the attribute providing instructions to highlight a line of text in which the search term is located.

40. The apparatus of claim 36 wherein the URL further includes at least one attribute, the attribute providing instructions to highlight a paragraph in which the search term is located.

41. An apparatus for displaying a Web page in a browser comprising:
means for requesting the Web page from a computer system using a uniform resource locator (URL), the URL including a search term;
means for receiving the Web page from the computer system;
means for determining whether there is a named anchor by the search term in the received Web page;
means for parsing the Web page for the search term if there is not a named anchor in the Web page by the search term; and
means for displaying the Web page at a location that coincides with the location of the search term in the Web page.

42. The apparatus of claim 41 wherein the URL further includes a first attribute, the first attribute providing instructions to highlight the search term.

43. The apparatus of claim 42 wherein the URL further includes a second attribute, the second attribute indicating which instance of the search term to highlight.

44. The apparatus of claim 42 wherein the URL further includes a second attribute, the second attribute indicating a line of text in which the search term is located to highlight.

45. The apparatus of claim 42 wherein the URL further includes a second attribute, the second attribute indicating a paragraph in which the search term is located to highlight.

46. An apparatus for providing a Web page to a computer system comprising:
means for receiving a request for the Web page from the computer system, the request including a uniform resource locator (URL) with a search term;
means for accessing the Web page identified by the URL;
means for determining whether there is a named anchor in the Web page by the search term;
means for parsing the Web page, if there is not a named anchor in the Web page by the search term, for the search term;
means for inserting in the Web page anchor tags around the search term if a named anchor is not found; and
means for transferring the Web page to the computer system.

47. The apparatus of claim 46 wherein the URL further includes a first attribute, the first attribute indicating that highlighting tags are to be inserted in the Web page around the search term.

48. The apparatus of claim 47 wherein the URL further includes a second attribute, the second attribute indicating around which instance of the search term anchor tags and highlighting tags are to be inserted.

49. The apparatus of claim 47 wherein the URL further includes a second attribute, the second attribute instructing that highlighting tags are to be inserted around a line of text containing the search term.

50. The apparatus of claim 47 wherein the URL further includes a second attribute, the second attribute instructing that highlighting tags are to be inserted around a paragraph containing the search term.

51. A system for displaying a document identified by a Uniform Resource Locator (URL) comprising:
at least one storage device for storing code data; and
at least one processor for processing the code data to access the document using the URL, the URL including a provided search term, to determine whether there is a named anchor in the document by the search term, to parse the document, if there is not a named anchor in the document by the search term, for the search term, and to display the document at a location that coincides with the location of the search term in the document.

52. The system of claim 51 wherein the URL further includes at least one attribute, the attribute indicating at which instance of the search term to display the document.

53. The system of claim 51 wherein the URL further includes at least one attribute, the attribute providing instructions to highlight the search term.

54. The system of claim 51 wherein the URL further includes at least one attribute, the attribute providing instructions to highlight a line of text in which the search term is located.

55. The system of claim 51 wherein the URL further includes at least one attribute, the attribute providing instructions to highlight a paragraph in which the search term is located.

56. A system for displaying a Web page in a browser comprising:
at least one storage device for storing code data; and
at least one processor for processing the code data to request the Web page from a computer system using a uniform resource locator (URL), the URL including a search term, to receive the Web page from the computer system, to determine whether there is a named anchor by the search term in the received Web page, to parse the Web page for the search term if there is not a named anchor in the Web page by the search term, and to display the Web page at a location that coincides with the location of the search term in the Web page.

57. The system of claim 56 wherein the URL further includes a first attribute, the first attribute providing instructions to highlight the search term.

58. The system of claim 57 wherein the URL further includes a second attribute, the second attribute indicating which instance of the search term to highlight.

59. The system of claim 57 wherein the URL further includes a second attribute, the second attribute indicating a line of text in which the search term is located to highlight.

60. The system of claim 57 wherein the URL further includes a second attribute, the second attribute indicating a paragraph in which the search term is located to highlight.

61. A first computer system for providing a Web page to a second computer system comprising:
at least one storage device for storing code data; and
at least one processor for processing the code data to receive a request for the Web page from the second computer system, the request including a uniform resource locator (URL) with a search term, to access the Web page identified by the URL, to determine whether there is a named anchor in the Web page by the search term, to parse the Web page, if there is not a named anchor in the Web page by the search term, for the search term, to insert in the Web page anchor tags around the search term if a named anchor is not found, and to transfer the Web page to the second computer system.

62. The system of claim 61 wherein the URL further includes a first attribute, the first attribute instructing that tags are to be inserted in the Web page to highlight the search term.

63. The system of claim 62 wherein the URL further includes a second attribute, the second attribute indicating around which instance of the search term anchor tags and highlighting tags are to be inserted.

64. The system of claim 62 wherein the URL further includes a second attribute, the second attribute instructing that highlighting tags are to be inserted around a line of text containing the search term.

65. The system of claim 62 wherein the URL further includes a second attribute, the second attribute instructing that highlighting tags are to be inserted around a paragraph containing the search term.
